(19) United States
(12) Patent Application Publication
(10) Pub. No.: US 2026/0102847 A1
(43) Pub. Date: Apr. 16, 2026

(54) CONTROL METHOD FOR LASER PROCESSING MACHINE

(71) Applicant: E&R ENGINEERING CORPORATION, Kaohsiung City (TW)

(72) Inventor: Schang-Jing HON, Kaohsiung City (TW)

(21) Appl. No.: 18/979,552

(22) Filed: Dec. 12, 2024

(30) Foreign Application Priority Data
Oct. 15, 2024 (TW) 113139216

(51) Int. Cl. B23K 26/08

(52) U.S. Cl. CPC B23K 26/0876

(57) ABSTRACT

A control method for a laser processing machine that includes a laser light generator, a controller and a stage for carrying a workpiece. The method has the steps of: dividing the workpiece into multiple task blocks each being equal to a scanning region of a laser beam; driving the stage to move at a constant speed along a first axis or a second axis so that the workpiece moves simultaneously relative to the laser light generator; the controller continuously receiving movement amounts of the stage measured by optical linear encoders for obtaining real-time coordinates T(x1ₜ,y1ₜ) of the workpiece while the stage is moving; calculating laser beam landing coordinates G(x2ₜ,y2ₜ) according to an equation R(xₜ,yₜ)=T(x1ₜ,y1ₜ)+G(x2ₜ,y2ₜ), where R(xₜ,yₜ) represents pre-stored target coordinates to be processed on the workpiece; and controlling the laser beam to irradiate onto the workpiece based on the laser beam landing coordinates G(x2ₜ,y2ₜ).

### CROSS REFERENCE TO RELATED APPLICATIONS

This non-provisional application claims the benefit under 35 U.S.C. § 119 (a) to patent application No. 113139216 filed in Taiwan on Oct. 15, 2024, which is hereby expressly incorporated by reference into the present application.

### BACKGROUND OF THE INVENTION

### 1. Field of the Invention

The present invention relates to a control method for a laser processing machine, particularly to a control method for improving processing efficiency of the laser processing machine.

### 2. Description of the Related Art

Generally, a laser processing machine may include a laser light generator and a stage. The laser light generator such as a Galvo scanner is installed in a relatively fixed position and emits a controllable laser beam onto a workpiece placed on the stage for laser processing. The purpose of the laser processing, for example, is to etch or drill certain pre-defined portions of the workpiece.

The stage is mounted under the laser light generator and configured to carry the workpiece so that the workpiece can be moved relative to the laser light generator. When performing the laser processing, the laser beam can be controlled to scan a limited scanning region within which the surface of the workpiece will be treated by the laser beam.

When the size or area to be processed on the workpiece is much larger than the scanning region of the laser beam, the stage will move the workpiece many times so that different areas of the workpiece can be respectively processed by the laser beam. That means the stage will frequently perform a series of operations such as starting to move, accelerating and braking. Meanwhile, in order to cooperate with the stage, the laser light generator will pause emission of the laser beam until the area to be processed has been moved within and stopped at the position of the scanning region. As a result, the laser processing efficiency is relatively low.

### SUMMARY OF THE INVENTION

An objective of the present disclosure is to provide a control method for a laser processing machine to improve laser processing efficiency thereof.

The laser processing machine includes a laser light generator, a controller and a stage for carrying a workpiece. The laser light generator is configured to irradiate a laser beam onto the workpiece.

According to the invention, the control method comprises steps of:
dividing the workpiece into multiple task blocks with each task block being equal to a scanning region of the laser beam in area, wherein multiple target points are predefined on the workpiece, and multiple target coordinates of the multiple target points are stored in the controller;
the controller driving the stage to move continuously at a constant speed for carrying the workpiece simultaneously relative to the laser light generator;
the controller continuously receiving a first movement amount of the stage along a first axis as well as a second movement amount of the stage along a second axis while the stage is moving continuously, thereby obtaining real-time coordinates T(x1ₜ,y1ₜ) of the workpiece at any time, wherein the first movement amount and the second movement amount are respectively measured by a first optical linear encoder and a second optical linear encoder beside the stage;
the controller calculating laser beam landing coordinates G(x2ₜ,y2ₜ) according to a relationship equation by using the real-time coordinates T(x1ₜ, y1ₜ) of the workpiece and the multiple target coordinates R(xₜ, yₜ),
where the relationship equation is R(xₜ,yₜ)=T(x1ₜ,y1ₜ)+G(x2ₜ,y2ₜ), wherein xₜ=x1ₜ+x2ₜ and yₜ=y1ₜ+y2ₜ; and
the controller controlling the laser light generator to irradiate the laser beam onto the workpiece according to the laser beam landing coordinates G(x2ₜ,y2ₜ).

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a laser processing machine.

FIG. 2 is a flowchart of a control method for the laser processing machine.

FIG. 3 shows a workpiece been divided into multiple task blocks.

FIG. 4 is an operational schematic view showing movements of the workpiece carried by a stage.

FIG. 5A is an operational schematic view showing the relative positions between a coordinate R(500,500) and a workpiece that has been moved to a first real coordinate T(498,495).

FIG. 5B is another operational schematic view showing the relative positions between a target coordinate R(500,500) and the workpiece that has been moved to a second real coordinate T(498,498).

FIG. 6 shows two adjacent task blocks Bₐ and Bₐ₊₁ being partially within a scanning region S of a laser beam.

FIG. 7 shows multiple task blocks being processed according to a predetermined processing sequence.

FIGS. 8A and 8B show a single task block being processed through two rounds of laser processing.

### DETAILED DESCRIPTION OF THE INVENTION

Directional terms as used herein, for example, up, down, right, left, front, back, top, bottom are made only with reference to the figures as illustrated and are not intended to imply absolute orientation unless otherwise specified.

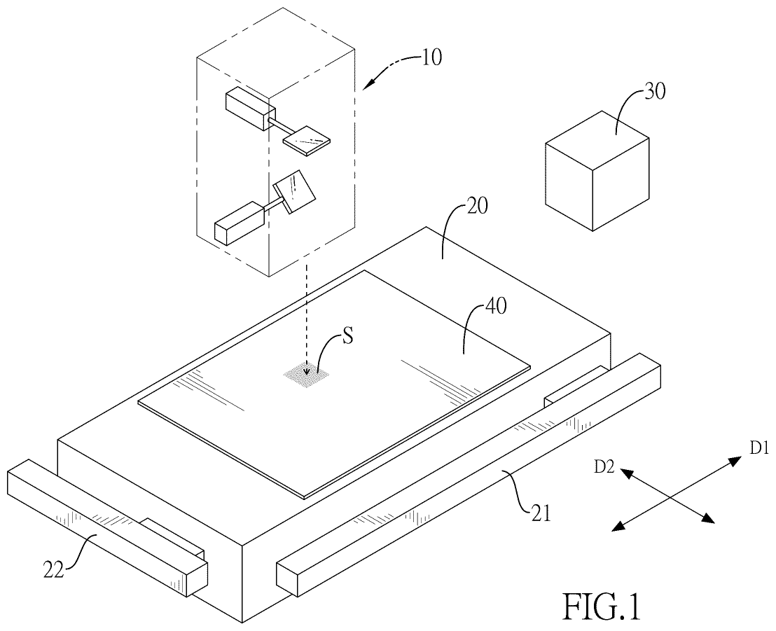

With reference to FIG. 1, a laser processing machine may comprise a laser light generator 10, a stage 20 and a controller 30. The controller 30 electrically connects to and controls the laser light generator 10 and the stage 20.

The laser light generator 10 such as a Galvo scanner is disposed above and fixed relative to the stage 20. The laser light generator 10 is configured to generate and output a laser beam for processing a workpiece 40 of a sheet-type object such as a substrate. The laser beam is reachable to any point in a certain region on a plane, referring to a scanning region S of the laser beam hereinafter.

The stage 20 is disposed under the laser light generator 10 and controlled to move along a first axis D1 and a second axis D2 by the controller 30. The first axis D1 such as the X-axis is perpendicular to the second axis D2 such as the Y-axis. With the support of the stage 20, the workpiece 40 is movable freely along the first axis D1 and the second axis D2 to be irradiated by the laser beam. In a preferred embodiment, the stage 20 has a supporting plane larger than the workpiece 40 in area so that the workpiece 40 can be placed thereon entirely.

A first optical linear encoder 21 and a second optical linear encoder 22 are mounted beside two sides of the stage 20 respectively for measuring a first movement amount of the stage 20 along the first axis D1 and a second movement amount of the stage 20 along the second axis D2. Both the first and second movement amounts are provided to the controller 30. Because the workpiece 40 has been held on the stage 20 at a known position and the relative positional relationship between the workpiece 40 and the stage 20 is also known, the controller 30 can calculate a real-time coordinate T(xₜ, yₜ) of the workpiece 40 moving at any time based on the first and second movement amounts measured by the two optical linear encoders 21, 22. With the high resolution of the optical linear encoders 21, 22, the first and second movement amounts in response to the moving of the stage 20 can be measured accurately, thereby computing a reliable real-time coordinate T(xₜ, yₜ) of the workpiece 40.

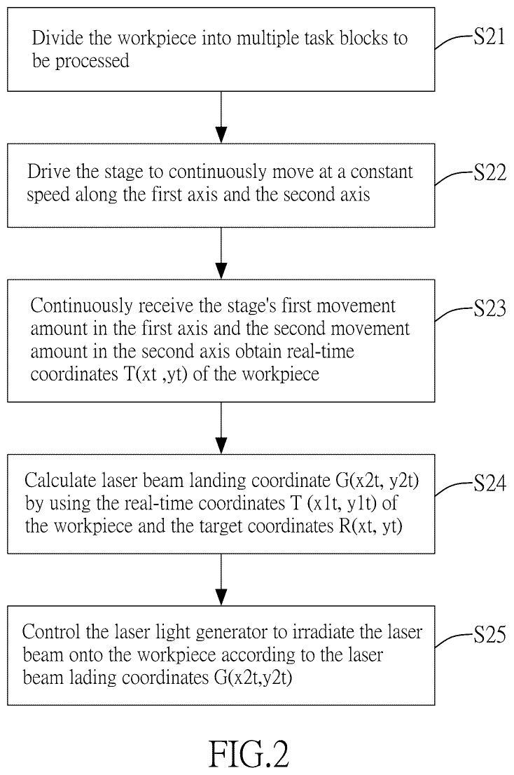

While the stage 20 is moving, the controller 30 controls the laser light generator 10 simultaneously to irradiate the laser beam onto the workpiece 40. With reference to FIG. 2, the control method for the laser processing machine of the present invention includes steps as follows.

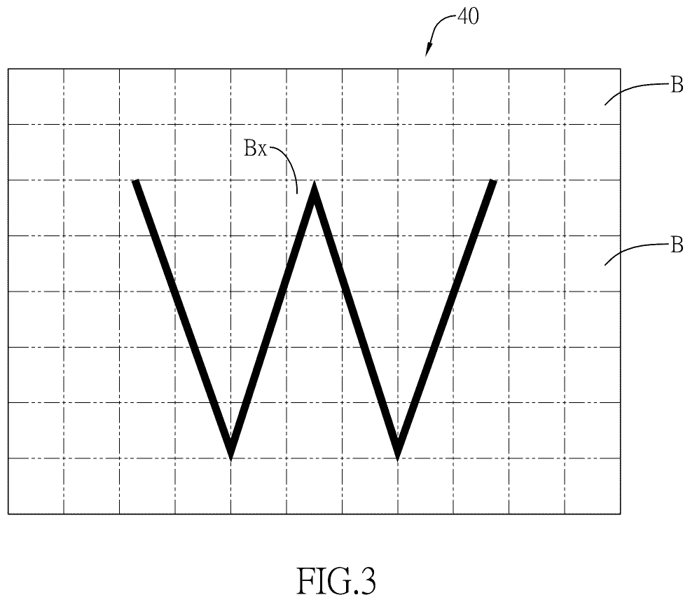

S21: Divide the workpiece 40 into multiple task blocks to be processed. As shown in FIG. 3, since the size of the workpiece 40 is usually larger than the scanning region S of the laser beam, the workpiece 40 is defined or zoned into multiple areas called task blocks B to be processed. For example, the workpiece 40 may be zoned into n columns with each column having m task blocks, totally having n×m task blocks. Each task block B has a size equal to the scanning region S in area.

Multiple target points R, which mean positions planned to be irradiated by the laser beam on the workpiece 40, may be distributed in all or some of the task blocks B. As an example, the workpiece 40 shown on FIG. 3 is planned to be processed by the laser beam along a pattern or a path “W”. The pattern “W” is deemed as a cluster composed of multiple target points R. Positions of the multiple target points R are known parameters and pre-stored in the controller 30 as target coordinates, for example stored in a memory of the controller 30. In one embodiment, all the target points R are distributed on a continuous path. In another embodiment, the continuous path goes through each of the task blocks B. The coordinates of the target points R on the workpiece 40 are represented as R(xₜ, yₜ), hereinafter referred to as target coordinates R(xₜ, yₜ). Parameters “xₜ” and “yₜ” commonly represent the position to be processed by the laser beam at a pre-determined time “t”, wherein the target coordinates R(xₜ, yₜ) are time-correlated parameters. The target coordinates R(xₜ, yₜ) may be absolute coordinates.

S22: The controller 30 drives the stage 20 to move continuously at a constant speed for carrying the workpiece 40 relative to the laser light generator 10. The stage 20 may move along the first axis and the second axis. For example, when the stage 20 is controlled to move along an S-curved path relative to the laser light generator 10, the stage 20 first moves forward along the first axis D1 so that the task blocks B in one column of the workpiece 40 will be processed from the topmost one to the bottommost one sequentially. And then, the stage 20 moves along the second axis D2 by a short distance to turn to a next column and subsequently moves along the first axis D1 again in reverse, thereby processing task blocks B of the next column from the bottommost one to the topmost one sequentially.

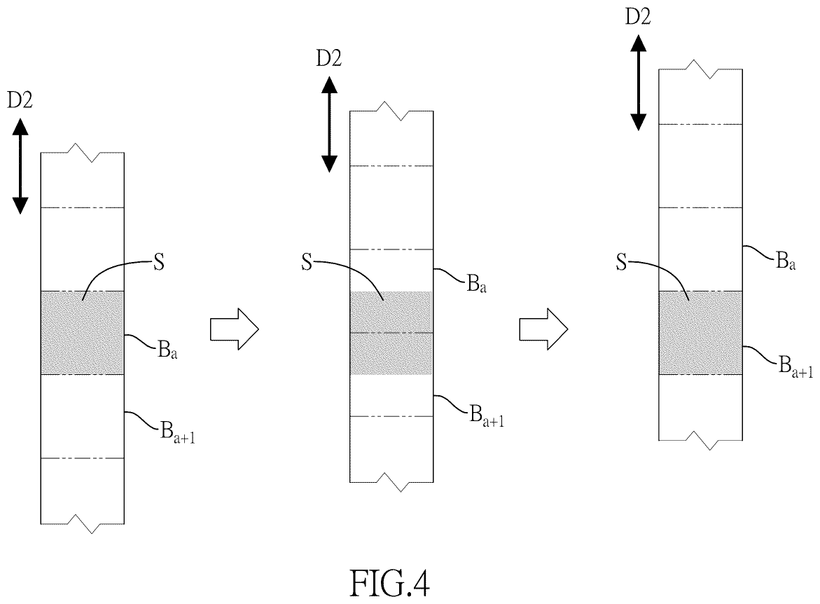

With reference to FIGS. 1 and 4, the scanning region S of the laser beam is illustrated as a gray region. As the stage 20 continuously moves forward along one axis such as the second axis D2, the area to be processed of the workpiece 40 within the scanning region S will be transitioned from a present task block Bₐ to the subsequent task block Bₐ₊₁. It is noted that the scanning region S of the laser beam is fixed relative to the workpiece 40.

S23: The controller 30 continues to receive the first movement amount along the first axis D1 and the second movement amount along the second axis D2 of the stage 20 to obtain real-time coordinates T(x1ₜ,y1ₜ) of the workpiece 40. As described above, since the two optical linear encoders 21, 22 continuously detect the position changing of the stage 20, the controller 30 is able to recognize the position of the stage 20 in real time according to data output by the two optical linear encoders 21, 22. The first movement amount in the first axial direction D1 and the second movement amount in the second axial direction D2 are used to calculate real-time coordinates T(x1ₜ, y1ₜ) of the workpiece 40 at any time. The parameters “x1ₜ” and “y1ₜ” of the real-time coordinate T(x1ₜ, y1ₜ) indicate a position represented by the X-axis and the Y-axis coordinates where the workpiece 40 reaches at the time “t”.

S24: The controller 30 calculates laser beam landing coordinate G(x2ₜ, y21) according to a relationship equation by using the real-time coordinates T(x1ₜ, y1ₜ) of the workpiece 40 and the target coordinates R(xₜ, yₜ). Each laser beam landing coordinate G(x2ₜ, y2ₜ) means an absolute coordinate in the scanning region S at which the laser beam is planned to irradiate at the time t. The relationship equation for calculating the laser beam landing coordinate G(x2ₜ, y2ₜ) is expressed as follows:

$$R ( {x}_{t} , {y}_{t} ) = T ( x {1}_{t} , y {1}_{t} ) + G ( x {2}_{t} , y {2}_{t} ) ,$$

wherein, xₜ=x1ₜ+x2ₜ and yₜ=y1ₜ+y2ₜ

S25: The controller 30 controls the laser light generator 10 to irradiate the laser beam onto the workpiece 40 according to the laser beam landing coordinates G(x2ₜ,y2ₜ).

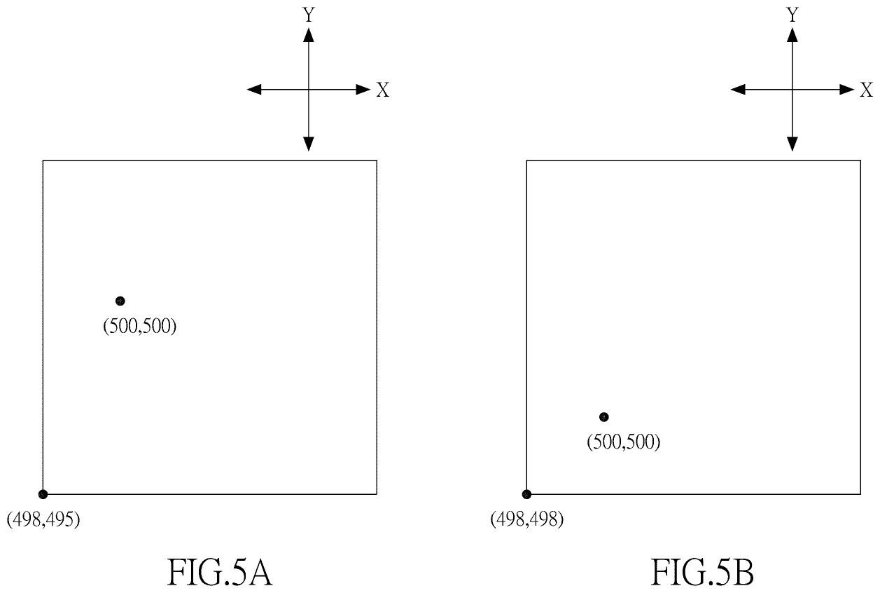

For example, with reference to FIG. 5A, for the known target coordinate R(500,500), when the workpiece 40 on the stage 20 is moved to the position of the real-time coordinate T(498,495), the laser beam landing coordinate G(x2ₜ,y2ₜ) calculated by the controller 30 is G(2,5) according to the relationship equation. The laser beam should land or irradiate at the position that is 2 units away on the X-axis and 5 units away on the Y-axis relative to the real-time coordinate T(498,495) to satisfy the relationship equation R(500,500)=T(498,495)+G(2,5).

For another example, with reference to FIG. 5B, for the same known target coordinate is R(500,500), when the workpiece 40 on the stage 20 is moved to the position of the real-time coordinate T(498,498), the laser beam landing coordinate G(x2ₜ,y2ₜ) calculated by the controller 30 would be G(2,2) according to the relationship equation. The laser beam should land or irradiate at the coordinate that is 2 units away on the X-axis and 2 units away on the Y-axis relative to the real-time coordinate T(498,498) to satisfy the relationship equation R(500,500)=T(498,498)+G(2,2).

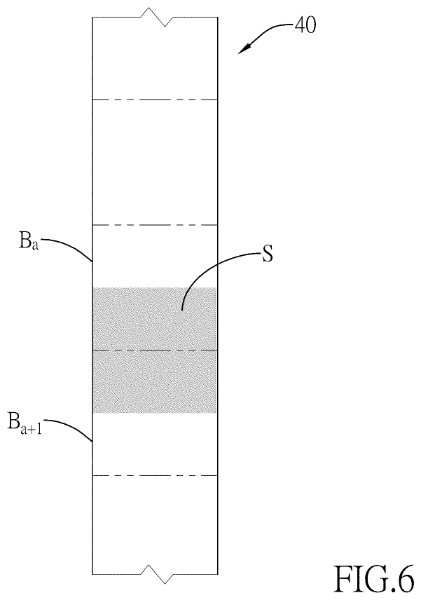

According to the present invention, the stage 20 continuously moves at a constant speed while the laser light generator 10 is emitting the laser beam to process the workpiece 40, instead of moving the workpiece 40 to a predetermined position and then stopping to wait for the laser beam. With reference to FIG. 6, as long as a part of the task block Bₐ₊₁ adjacent to the previous task block Bₐ moves in the scanning region S of the laser beam, the laser light generator 10 is allowed to process the part in the task block Bₐ₊₁ which has been moved into the scanning region S. There is no need to wait until the task block Bₐ₊₁ completely moves into the scanning range S before emitting the laser beam. Since the stage 20 is moved continuously without being frequently started and braked, the laser processing efficiency is improved.

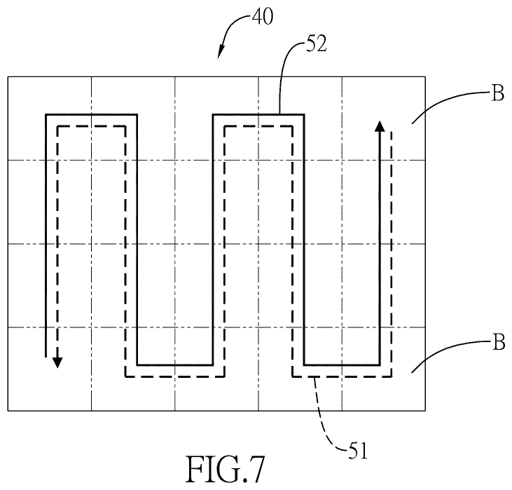

With reference to FIG. 7, as discussed in foregoing step S22, when the stage 20 is controlled to move along an S-curved path, the workpiece 40 simultaneously moves along the same path as shown by trajectories 51, 52. In an embodiment of the present invention, the task blocks B of the workpiece 40 will be processed by multiple rounds of laser processing. For example, in the first round of laser processing, the stage 20 moves along a forward direction such as the trajectory 51 indicated by broken lines, and the laser processing is performed sequentially beginning from the task block B at upper right to the task block B at the lower bottom. In the second round of laser processing, the stage 20 moves along in a reverse direction such as the trajectory 52 indicated by solid lines, and the laser processing is performed sequentially beginning from the task block B at the lower bottom to the task block at the upper right.

The single task block B may pass through the scanning region S many times and be irradiated by the laser beam at different target points R in the same task block B.

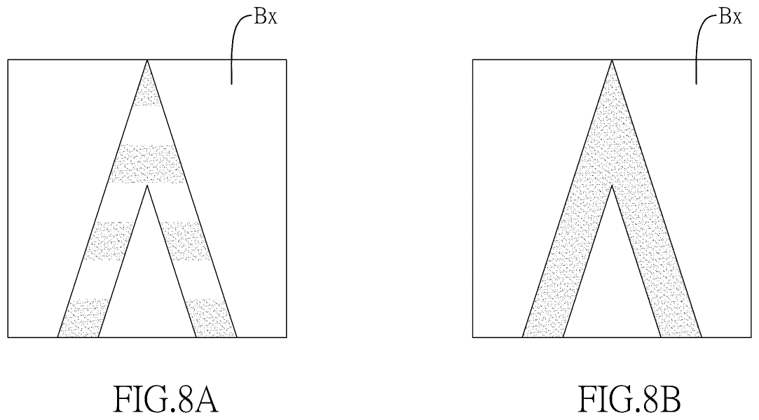

Taking the task blocks Bx at middle top in FIG. 3 as an example, the laser beam is configured to process a part of target points R illustrated by gray regions as shown on FIG. 8A in the first round of laser processing. Subsequently, the laser beam is configured to process remaining target points R in second round of laser processing. After the two rounds of laser processing, all the target points R being processed commonly form a reversed V pattern as shown in FIG. 8B, i.e. the center vertex of the “W” pattern in FIG. 3.

According to the present invention, the stage 20 is controlled to continuously move at a constant speed to simultaneously carry the workpiece 40 relative to the laser light generator 10. Even the workpiece 40 is constantly changing its real-time coordinates T(x1ₜ, y1ₜ), the control device 30 can track the real-time coordinates T(x1ₜ, y1ₜ), calculate and update the laser beam landing coordinates (x2ₜ, y2ₜ) respectively corresponding to the real-time coordinates T (x1ₜ, y1ₜ) at each time.

Because the resolution of the two optical linear encoders 21, 22 is on the order of micrometers (μm) or nanometers (nm), both the optical linear encoders 21, 22 can accurately measure the minor changes in the real-time coordinates T(x2ₜ, y2ₜ) of the workpiece 40 even it merely moves over a short distance. The controller 30 accordingly controls the laser light generator 10 to emit the laser beam landing at positions based on the laser beam landing coordinates G(x2ₜ, y2ₜ) in real time.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A control method for a laser processing machine having a laser light generator, a controller and a stage being movable for carrying a workpiece, the laser light generator configured at a fixed position relative to the stage to irradiate a laser beam onto the workpiece, the method comprising steps of:
dividing the workpiece into multiple task blocks with each task block being equal to a scanning region of the laser beam in area, wherein multiple target points are predefined on the workpiece, and multiple target coordinates (xₜ, yₜ) of the multiple target points are stored in the controller;
the controller driving the stage to continuously move at a constant speed to simultaneously carry the workpiece relative to the laser light generator;
the controller continuously receiving a first movement amount of the stage along a first axis as well as a second movement amount of the stage along a second axis while the stage is continuously moving, thereby obtaining real-time coordinates T(x1ₜ,y1ₜ) of the workpiece at any time, wherein the first movement amount and the second movement amount are respectively measured by a first optical linear encoder and a second optical linear encoder beside the stage;
the controller calculating laser beam landing coordinates G(x2ₜ,y2ₜ) according to a relationship equation by using the real-time coordinates T(x1ₜ, y1ₜ) of the workpiece and the multiple target coordinates R(xₜ, yₜ),
where the relationship equation is R(xₜ,yₜ)=T(x1ₜ,y1ₜ)+G(x2ₜ,y2ₜ), wherein xₜ=x1ₜ+x2ₜ and yₜ=y1ₜ+y2ₜ; and
the controller controlling the laser light generator to irradiate the laser beam onto the workpiece according to the laser beam landing coordinates G(x2ₜ,y2ₜ).

2. The method as claimed in claim 1, wherein the controller calculates real-time coordinates T(x1ₜ, y1ₜ) of the workpiece according to the first movement amount and the second movement amount.

3. The method as claimed in claim 1, wherein the laser beam landing coordinates G(x2ₜ,y2ₜ) are absolute coordinates in the scanning region of the laser beam.

4. The method as claimed in claim 1, wherein the controller drives the stage to move along an S-curved path at the constant speed.

5. The method as claimed in claim 1, wherein each of the first optical linear encoder and the second optical linear encoder has a resolution on the order of micrometers or nanometers.

6. The method as claimed in claim 1, wherein the multiple target points are distributed to form a continuous path on the workpiece.

7. The method as claimed in claim 6, wherein the continuous path passes through each of the multiple task blocks.

8. The method as claimed in claim 1, wherein the multiple task blocks of the workpiece are processed by multiple rounds of laser processing.

9. The method as claimed in claim 1, wherein the laser light generator is a Galvo scanner configured above the stage.
